(19) United States
(12) Patent Application Publication
(10) Pub. No.: US 2003/0141923 A1
(43) Pub. Date: Jul. 31, 2003

(54) Resistance mirror circuit

(75) Inventors: Jing-Meng Liu, Hsinchu City (TW); Kent Hwang, Taoyuan Hsien (TW); Chao-Hsuan Chuang, Hsinchu City (TW); Cheng-Hsuan Fan, Hsinchu Hsien (TW)

Correspondence Address: BRUCE H. TROXELL, SUITE 1404, 5205 LEESBURG PIKE, FALLS CHURCH, VA, 22041, US

(73) Assignee: Richtek Technology Corp.

(21) Appl. No.: 10/229,160

(22) Filed: Aug. 28, 2002

(30) Foreign Application Priority Data
Jan. 25, 2002 (TW) 91101283

(51) Int. Cl. G05F 1/10

(52) U.S. Cl. 327/538

(57) ABSTRACT

A resistance adjustable of resistance mirror circuit comprises: a master resistor R₀, a reference current source terminal providing a current value I₀ through the master resistor R₀ to ground; a first transistor; a current mirror source terminal providing a current value nI₀, through the first transistor to ground; an operational amplifier having a positive terminal connecting to a drain of the first transistor, a negative terminal connecting to the other terminal of the master resistor R₀, and an output terminal connecting to a gate of the first transistor; a mirror resistor set composed of a plurality of transistors in parallel each other and having their source electrode connecting to ground. Each transistor of the mirror resistor set has a ratio of channel width over channel length being m-fold of that of the first transistor, where m, n is any positive numbers. Since gates of the transistors connect to the output terminal of the operational amplifier, each of the transistors therefore has an equivalent resistance R_{eq}=(1/nm)R₀.

### FIELD OF THE INVENTION

The present invention relates to a resistance equivalent circuit, and more particularly, to an equivalent circuit of resistance mirror consisting of current mirror circuits and a mirror resistor set.

### DESCRIPTION OF THE PRIOR ART

In general, to modulate the electrical characteristics of analog integrated circuits is usually by means of the resistance, capacitance or inductance adjustment. Among of them the most preferably is conducted, by adjusting the resistance for its simple, common, low cost and easy to handle.

Whereas, to achieve a specified function, for example, tuning the central frequency of multistage band pass filter circuit systems and/or sub-systems from one position to another, each sub-system should have a consistent modulation. However, if it is done by individually adjusting each resistor of the system, It would be time consuming and detrimental to the precision of the system, even more causes the circuit failed. Therefore, to overcome above-mentioned drawbacks, it is desired to have a new circuit technique for band-pass circuit that a resistance mirror circuit contains a master resistor and slave resistors. The latter is then controlled in accordance with a resistance change of the master resistor.

The object of the present is thus to provide such desired circuit.

### SUMMARY OF THE INVENTION

It is therefore a primary objective of the present invention to provide a resistance mirror circuit having a set of adjustable resistors in accordance with a master resistance to meet different requirement of circuit application.

The present invention disclosed a resistance mirror circuit having a set of adjustable resistors with resistance in accordance with a master resistor. In the first preferred embodiment, the circuit comprises: (1) a master resistor R₀, (2) a reference current source terminal providing a current value I₀ through the master resistor R₀ to ground;(3) a first transistor; (4) a current mirror source terminal providing a current value nI₀, through the first transistor to ground; (5) an operational amplifier having a positive terminal connecting to a drain of the first transistor, a negative terminal connecting to the other terminal of the master resistor R₀, and an output terminal connecting to a gate of the first transistor; (6) a mirror resistor set consisting of a plurality of transistors in parallel each other and having their source electrodes connecting to ground. Each transistor of the mirror resistor set has a ratio of channel width over channel length being m-fold of that of the first transistor, where m, n is any positive numbers. Since gates of the transistors connect to the output terminal of the operational amplifier, each of the transistors therefore has an equivalent resistance R_{eq}=(1/nm)R₀.

The second embodiment according to the present invention comprises: (1) a master resistance R₀; (2) a first transistor, having a ratio of channel width over channel length thereof equal to W/L. (3) a reference current source terminal providing a reference current I₀, the reference current being through first transistor, and the master resistance R₀ to ground; (4) a second transistor, having a ratio of channel width over channel length thereof equal to nW/L; (5) a third transistor having a ratio of channel width over channel length thereof equal to nW/L; (6) a current mirror source terminal providing a mirror current value of nI₀, in series connecting with the second transistor, the third transistor to ground, wherein the second transistor has a gate electrode connecting to a drain electrode, therefore the second transistor has the same current density and V_{GS} voltage as the first transistor, where V_{GS} voltage is voltage of the gate electrode to source electrode; (7) a mirror resistor set consisting of a plurality of transistors in parallel and with their source electrode connecting to ground, and each transistors having a ratio of channel width over channel length thereof equal to nm W/L, wherein n, m are positive number; (8) an operational amplifier having a negative terminal connecting to a drain and a gate electrode of the second transistor, and output a signal to a gate of the third transistor and all gate electrodes of the transistors of the mirror resistor set; (9) a reference signal controlling a gate bias of said first transistor and feeding to a positive terminal of said operational amplifier so that a voltage across the master resistor R₀ is equal to the source voltage of the second transistor, therefore, each transistor of the mirror resistor set has an equivalent resistance R_{eq}=(1/nm)R₀.

The transistors in the present invention are not limited in depleted mode transistors or enhanced transistors.

### BRIEF DESCRIPTION OF THE DRAWINGS

FIG. 1 shows the relationship between a drain current (I_{D}) and a voltage of drain to source (V_{DS}) in an ohmic region of a field effect transistor.

FIG. 2 is schematic drawing of a resistance mirror circuit having resistance adjustable according to the first embodiment of the present invention.

FIG. 3 is schematic drawing of a resistance mirror circuit having resistance adjustable according to the second embodiment of the present invention.

### DESCRIPTION OF THE PREFERRED EMBODIMENT

The present invention discloses a resistance mirror circuit consisted of a current mirror circuit, an operational amplifier and a mirror resistor set. The mirror resistor set consisting of a plurality of transistors. Each of the transistors is to work in the ohmic region and thus functions as a resistor with resistance in accordance with a master resistor. Therefore, any resistance corresponding to each transistor desired to change, is merely to change resistance of the master resistor. Thus, the present invention is especially available for those bandpass multi-steps filter integrated circuit which is designed with adjustable band frequency.

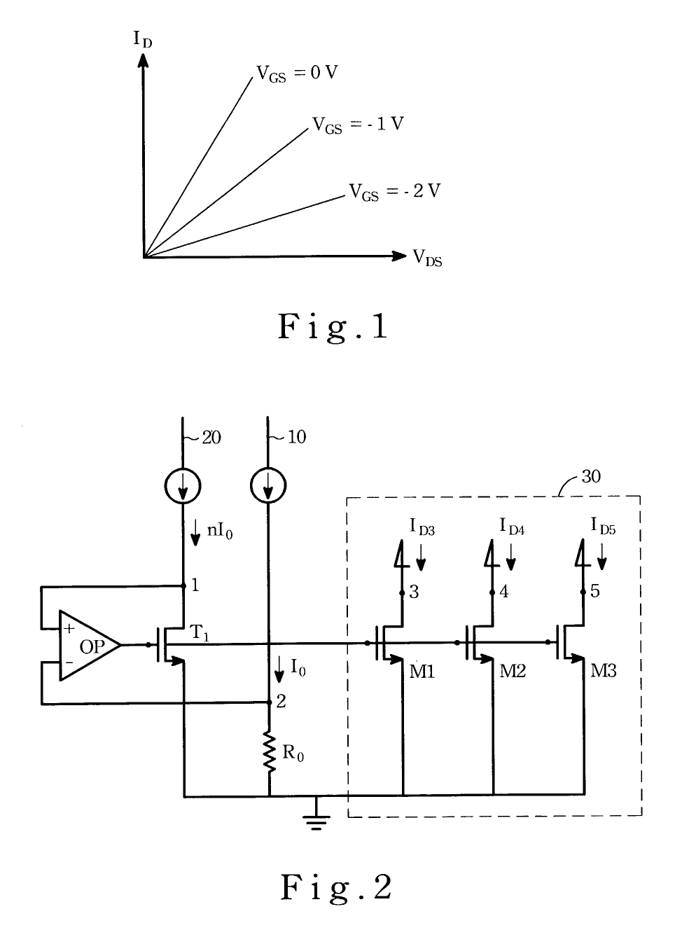

FIG. 1 shows a linear relationship of I_{D} (drain current) versus V_{DS} (voltage of drain to source) for a field effect transistor (or metal oxide semiconductor transistor) while I_{D} and V_{DS} are small. The slopes of curves are varied with V_{GS}, voltage of gate to source.

The curves shown in FIG. 1, is an example of a depleted-type field effect transistor. The slope, said the conductance is maximum or said resistance is minimum when V_{GS}=0. On the contrary, for enhanced-type field effect transistor, the larger the V_{GS} is, the smaller resistance will be. Therefore, if the gate voltage is properly adjustment, no matter the depleted-type or enhanced-type field effect transistor is employed, the transistors can be served as adjustable resistors.

The present is thus utilized the linear region of V_{DS} and I_{D} curve of the transistor, in the linear region, the R_{DS}, the equivalent resistance of drain to source is:

R_{DS}=V_{DS}/I_{D}

Where, I_{D}=K(W/L)(V_{GS}−V_{TH})V_{DS}, then:

R_{DS}=V_{DS}/I_{D}=1/K(L/W)(V_{GS}−V_{TH})⁻¹

where V_{TH}: a threshold voltage;

Accordingly, R_{DS} is a function of V_{GS} so R_{DS} of one or several transistors is adjusted in response to a proper V_{GS} adjustment by means of a feedback circuit. In the situation, R_{DS} is linear proportional to the predetermined resistor R₀. In other words, the resistance R_{DS} of transistor can be varied in response to a predetermined resistor, or say master resistor R₀ in feedback circuit.

Please refer to FIG. 2, a view of a resistance mirror circuit according to the first embodiment of the present invention. The resistance mirror circuit comprises (1)a current mirror source, (2) a plurality of transistors M1, M2, and M3 worked in the ohmic region, (3) an operational amplifier OP, a transistor T1 and a master resistor R₀. The current mirror source, has a current reference source 10 providing a reference current I₀, which passes through a node 2 and the master resistor R₀ to ground and, a current mirror source 20 providing a mirror current nI₀, n is any positive number, sinking to ground via the transistor T1 which has a ratio of channel width over channel length (W/L) equal to x. The transistors M1, M2, and M3 are in parallel and with source terminals connected to ground; The output terminal of the operational amplifier OP provides an input signal and feeds to transistor T1 and transistors M1, M2, and M3 through gate electrodes to provide a proper gate bias. Furthermore, signal from the drain terminal (node 1) of the transistor T₁ (node 1) is feedback to the positive terminal of the operational amplifier OP thereto provides an input signal. And the negative terminal of the operational amplifier op connects to the node 2 of the reference current source terminal 10.

The resistor R₀ connected to the node 2 is to function as a master resistor. In other words, if a resistance of the master resistor R₀ is changed, resistances of all mirror resistors 30 are followed. Since the voltage (V₂) of the node 2 is equal to I₀R₀ and feedbacks to the negative terminal of the operational amplifier OP without connecting any resistor, As a result, the relationships as follows are established:

V₁=V₂=I₀R₀

Therefore, the equivalent resistance of the transistor T₁ is:

R_{eqT1}=V₁/nI₀=(1/n)R₀

Furthermore, since the gates of the transistors M₁, M₂, M₃ connect to the gate of the transistor T₁ and, the transistors M₁, M₂, M₃ have a channel width over channel length=mx, where x=W/L of the transistor T₁. Consequently, for the drain current I_{D2} at node 1, of the transistor I_{D2}=nI₀, the drain current I_{D3}, I_{D4}, I_{D5} at node 3, 4,and 5 are:

I_{D3}=I_{D4}=I_{D5}=mnI₀.

Each transistor M3, M4, and M5 in mirror resistor set 30 has an equivalent resistance:

R_{eqM1}=R_{eqM2}=R_{eqM3}=V₁/nmI₀=(1/nm)R₀

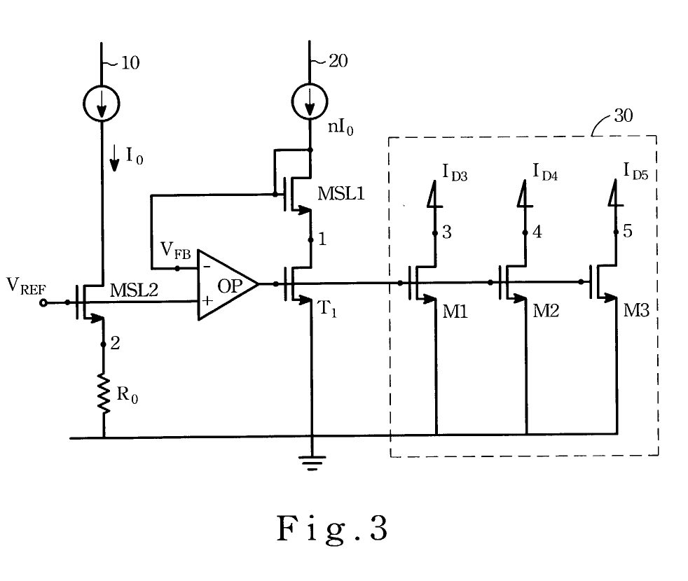

The second embodiment of resistor mirror circuit according to the present invention is disclosed in FIG. 3. Please refer to FIG. 3 the resistance mirror circuit comprises: (1) a current mirror circuit 10, 20, (2) an operational amplifier OP, (3) a first transistor MSL2, (4) a second transistor MSL₁ (5) a third transistor T₁, (6) a master resistor R₀ and (7) a mirror resistor set 30. The reference current source terminal 10 of the current mirror circuit provides constant reference current I₀, and the mirrored current source 20 provides a current of about n-fold of I₀. The reference current 10 from reference current source 10 is through the first transistor MSL₂, node 2, and the master resistor R₀ to ground. The current mirror source 20 is through the second transistor MSL₁ and the third transistor T₁ to ground. The second transistor MSL₁ has a channel width over channel length ratio being n-fold of that of the first transistor MSL₂.

The mirror resistor set 30 is composed of a plurality of transistors M1, M2, M3, in parallel, as is shown in FIG. 3, having their source electrode connection to ground and having a channel width over channel length ratio of about m times of that of the third transistor T₁, where n, m are any positive numbers.

Moreover, the drain and the gate terminal of the second transistor MSL₁ are connected together and then negative feedback to the negative input terminal of the operational amplifier OP. The output terminal of the operational amplifier OP is connected to the gates of the third transistor T1. The positive terminal thereof is under controlled by a reference voltage signal V_{REF}, as shown in FIG. 3. Due to the negative feedback characteristic of the operational amplifier OP, the voltage V_{FB} is almost the same voltage as the reference voltage V_{REF}. In addition, the reference voltage signal V_{REF} also controls the gate bias of the first transistor MSL₂. Therefore, the V_{GS} of the first transistor MSL₂ is equal to that of the second transistor MSL1 when the current densities of these two transistors are identical. This is because the second transistor MSL₁ has a channel width over channel length ratio being n-fold of that of the first transistor MSL₂, and a constant current of the terminal of current mirror source 20 is also n-fold of that of the terminal of current reference source 10. The difference between the voltage V₂ of the node 2 and reference voltage signal V_{REF} is only V_{GS} of the first transistor MSL₂, that is, the voltage V₂ at node 2 is equal to the voltage V₁ at node 1. Consequently, as the foregoing description of the first embodiment, each transistor M₁, M₂, M₃ in the mirror resistors set has a equivalent resistance value:

R_{eqM1}=R_{eqM2}=R_{eqM3}=V₁/nmI₀=(1/nm)R₀

The benefits of the present invention are:

Resistance of each resistor in mirror resistor set is adjustable according to the master resistor and has an equivalent resistance value of R_{eqM}=(1/nm)R₀. It is thus easier and benefit to employ the resistance mirror circuit in multistage band pass filter circuits composed of the RC or RLC demanded with central frequency modulation.

Although the preferred embodiments have been described in some detail, the present invention is not limited therein, other modifications and alternations without departing from the spirit a scope of the present invention should be construed by the appended claim.

What is claimed is:

1. A resistance mirror circuit having a set of adjustable resistors, said resistance mirror circuit comprising:
a master resistance R₀;
a reference current source terminal providing a reference current with a value of I₀, said reference current being through said master resistance R₀ to ground;
a first transistor;
a current mirror source terminal providing a mirror current with a value being n-folds of I₀, said mirror current being through said first transistor to ground;
an operational amplifier having a positive terminal connecting to a drain electrode of said first transistor, a negative terminal connecting to a node between said master resistor R₀ and said reference current source terminal, and an output terminal connecting to said gate electrode of said first transistor; and
a mirror resistor set comprising a plurality of transistors in parallel and with their source electrode connecting to ground, said transistors of said mirror resistor set having a ratio of channel width to channel length being m-fold of that of said first transistor, all of gate electrodes of said transistors connecting to said output of said operational amplifier, said m, n are any positive number; and
therefore, each of said transistors having an equivalent resistance with a value of R_{eq}=(1/nm)R₀.

2. The resistance mirror circuit of claim 1 wherein said transistors of mirror resistor set are selected from depleted-type field effect transistors or enhanced-type field effect transistors.

3. A resistance mirror circuit having a set of adjustable resistors, said resistance mirror circuit comprising:
a master resistance R₀;
a first transistor, having a ratio of channel width over channel length thereof equal to W/L;
a reference current source terminal providing a reference current with a value of I₀, said reference current being through first transistor, and said master resistance R₀ to ground;
a second transistor, having a ratio of channel width over channel length thereof equal to n W/L;
a third transistor having a ratio of channel width over channel length thereof equal to n W/L;
a current mirror source terminal providing a mirror current value of nI₀, in series connecting with said second transistor, said third transistor to ground, wherein said second transistor has a gate electrode connecting to a drain and a gate electrode, therefore said second transistor has the same current density and V_{GS} voltage as said first transistor's, where V_{GS} voltage is a voltage drop between said gate electrode and said source electrode;
a mirror resistor set consisting of a plurality of transistors in parallel and with their source electrode connecting to ground, and each said transistors of said mirror resistor set having a ratio of channel width over channel length thereof equal to nm W/L, wherein n, m are positive number;
an operational amplifier having a negative terminal connecting to a drain electrode of said second transistor, and outputting a signal to a gate of said third transistor and all gate electrodes of said transistors of said mirror resistor set;
a reference signal controlling a gate bias of said first transistor and feeding to a positive terminal of said operational amplifier so that a voltage across said master resistor R₀ is equal to said source voltage of said second transistor, therefore, each transistor of said mirror resistor set having an equivalent resistance R_{eq}=(1/nm)R₀.

4. The resistance mirror of claim 3 wherein said transistors of mirror resistor set are selected from depleted-type field effect transistors or enhanced-type field effect transistors.
